(19) United States
(12) Patent Application Publication
(10) Pub. No.: US 2012/0031633 A1
(43) Pub. Date: Feb. 9, 2012

(54) FIRE SUPPRESSION APPARATUS AND CONTAINER DATA CENTER INCLUDING SAME

(75) Inventors: TSUNG-HAN SU, Tu-Cheng (TW); CHUN-MING CHEN, Tu-Cheng (TW)

(73) Assignee: HON HAI PRECISION INDUSTRY CO., LTD., Tu-Cheng (TW)

(21) Appl. No.: 12/886,506

(22) Filed: Sep. 20, 2010

(30) Foreign Application Priority Data
Aug. 9, 2010 (TW) 99126539

(51) Int. Cl. A62C 37/11

(52) U.S. Cl. 169/61

(57) ABSTRACT

A fire suppression apparatus includes a fire detector, a controller, a flame retardant gas source, a nozzle, and a valve. The fire detector detects fires in a container data center. An input of the controller is connected to the fire detector. An output of the controller is connected to a control terminal of the valve. An input of the valve is connected to the flame retardant gas source. An output of the valve is connected to the nozzle.

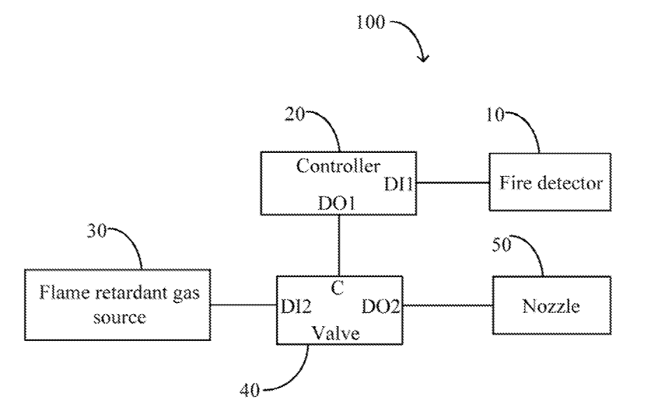

### BACKGROUND

1. Technical Field

The present disclosure relates to a fire suppression apparatus and a container data center including the fire suppression apparatus.

2. Description of Related Art

When a container data center is on fire, users usually enter the container data center to put the fire out with a hand-held fire extinguisher. However, it is dangerous for the user to enter the container data center during a fire.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, all the views are schematic, and like reference numerals designate corresponding parts throughout.

The figure is a block diagram of an exemplary embodiment of a fire suppression apparatus.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

Referring to the figure, an exemplary embodiment of a fire suppression apparatus 100 includes at least one fire detector 10, a controller 20, a flame retardant gas source 30, a valve 40, and a nozzle 50. The fire suppression apparatus 100 is mounted in a container data center.

The fire detector 10 may be an arcing detector, a temperature detector, or a smoke detector. The arcing detector detects arcing light when electric apparatus in the container data center is shorted. The temperature detector detects the temperature in the container data center and the rising rate of the temperature in the container data center. The smoke detector detects the smoke density in the container data center.

An input DI1 of the controller 20 is connected to the fire detector 10. An output DO1 of the controller 20 is connected to a control terminal C of the valve 40.

An input DI2 of the valve 40 is connected to the flame retardant gas source 30. An output DO2 of the valve 40 is connected to the nozzle 50.

The flame retardant gas source 30 stores flame-retardant gas, such as nitrogen, carbon dioxide, or heptafluoropropane.

The fire detector 10 sends out a detecting signal if the fire detector 10 detects that there is electrical arcing in the container data center, the temperature in the container data center is higher than a first predetermined value, the rising rate of the temperature in the container data center is higher than a second predetermined value, or the smoke density in the container data center is higher than a third predetermined value.

The controller 20 receives the detecting signal of the fire detector 10, and sends a control signal to the valve 40 to control the valve 40 to connect the flame retardant gas source 30 to the nozzle 50. The flame-retardant gas in the flame retardant gas source 30 flows into the container data center and suppresses the fire.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A fire suppression apparatus, comprising:
a fire detector mounted in a container data center, to detect fires in the container data center and send out a detecting signal if there is a fire;
a controller comprising an input connected to the first detector and an output to send out a control signal after the controller receives the detecting signal from the fire detector;
a flame retardant gas source storing flame-retardant gas;
a nozzle mounted in the container data center; and
a valve comprising a control terminal connected to the output of the controller to receive the control signal, an input connected to the flame retardant gas source, and an output connected to the nozzle, wherein the control signal of the controller controls the valve to connect the flame retardant gas source to the nozzle.

2. The fire suppression apparatus of claim 1, wherein the fire detector is an arcing detector, the arcing detector sends out the detecting signal if there is arcing light in the container data center, the controller determines that there is a fire.

3. The fire suppression apparatus of claim 1, wherein the fire detector is a temperature detector, the temperature detector sends out the detecting signal if the temperature in the container data center is more than a first predetermined value or the rising rate of the temperature in the container data center is more than a second predetermined value, the controller determines that there is a fire.

4. The fire suppression apparatus of claim 1, wherein the fire detector is a smoke detector, the smoke detector sends out the detecting signal if the smoke density in the container data center is more than a predetermined value, the controller determines that there is a fire.

5. The fire suppression apparatus of claim 1, wherein the flame-retardant gas is nitrogen, carbon dioxide, or heptafluoropropane.

6. A container data center, comprising:
a fire suppression apparatus, wherein the fire suppression apparatus comprises:
a fire detector to detect fires in the container data center and send out a detecting signal if there is a fire;
a controller comprising an input connected to the first detector and an output to send out a control signal after the controller receives the detecting signal from the fire detector;
a flame retardant gas source storing flame-retardant gas;
a nozzle; and
a valve comprising a control terminal connected to the output of the controller to receive the control signal, an input connected to the flame retardant gas source, and an output connected to the nozzle, wherein the control signal of the controller controls the valve to connect the flame retardant gas source to the nozzle.

7. The container data center of claim 6, wherein the fire detector is an arcing detector, the arcing detector sends out the detecting signal if there is arcing light, the controller determines that there is a fire.

8. The container data center of claim 6, wherein the fire detector is a temperature detector, the temperature detector sends out the detecting signal if the temperature is more than a first predetermined value or the rising rate of the temperature is more than a second predetermined value, the controller determines that there is a fire.

9. The container data center of claim 6, wherein the fire detector is a smoke detector, the smoke detector sends out the detecting signal if the smoke density is more than a predetermined value, the controller determines that there is a fire.

10. The container data center of claim 6, wherein the flame-retardant gas is nitrogen, carbon dioxide, or heptafluoropropane.
